(19) United States
(12) Patent Application Publication
(10) Pub. No.: US 2012/0065323 A1
(43) Pub. Date: Mar. 15, 2012

(54) TEMPORARY COATINGS

(76) Inventors: Ritch Overton, Pelham, AL (US); William C. Floyd, Chester, SC (US)

(21) Appl. No.: 13/254,798

(22) PCT Filed: Mar. 4, 2010
(86) PCT No.: PCT/US10/26134

§ 371 Date: Nov. 21, 2011

Related U.S. Application Data
(60) Provisional application No. 61/158,327, filed on Mar. 6, 2009.

(51) Int. Cl. C09D 133/02; C09D 133/10; C09D 133/08; C09D 133/12

(52) U.S. Cl. 524/559; 524/556; 524/564; 524/560

(57) ABSTRACT

A coating having a highly-carboxylated emulsion polymer that is polymerized from (i) olefinically-unsaturated hydrophobic monomers and (ii) olefinically-unsaturated carboxylic acid-functional monomers. The coating may be removed by an alkaline solution.

PRIOR RELATED APPLICATION DATA

This application is a U.S. National Phase of International Patent Application No. PCT/US2010/026134, filed Mar. 4, 2010, which claims priority to U.S. Provisional Patent Application Ser. No. 61/158,327, filed Mar. 6, 2009, which is incorporated by reference.

### TECHNICAL FIELD

The invention relates to temporary coatings, removers of temporary coatings, and methods for applying and removing temporary coatings.

### BACKGROUND

A coating is a covering that is applied to the surface of an object, usually referred to as substrates. In many cases coatings are applied to improve surface properties of the substrate, such as appearance, adhesion, corrosion resistance, wear resistance, and scratch resistance. The coating forms an essential part of the finished product.

There is always a need for an improved coating. It is to this need, among others, that this application is directed.

### SUMMARY

Briefly, this application discloses an aqueous coating having a highly carboxylated emulsion polymer that is polymerized from olefinically-unsaturated hydrophobic monomers and olefinically-unsaturated carboxylic acid-functional monomers. The coating can also include a surfactant and water. In one example, the carboxylic acid-functional monomers were more than 4% by weight of the polymer and the pH was less than about 7.

In one specific embodiment, the hydrophobic monomers can be selected from ethyl acrylate, butyl acrylate, methyl methacrylate, butyl methacrylate, 2-ethylhexyl acrylate, styrene, vinyl acetate, butadiene, Veova® monomers (neononanoic acid vinyl ester, neodecanoic acid vinyl ester, neoundecanoic acid vinyl ester, neododecanoic acid vinyl ester) or combinations thereof. The carboxylic acid-functional monomers can be selected from the group consisting of acrylic acid, methacrylic acid, Itaconic acid, crotonic acid, mono alkyl maleate, maleic acid, and fumaric acid, or combinations thereof.

In another specific embodiment, the coating can include copolymerizable surfactants that include monomers that have a hydrophobic segment and an ionizable and/or hydrophilic segment. The hydrophilic segment extends into the aqueous solution phase and thereby provides a steric or coulombic charge barrier against particle coagulation.

In another specific embodiment, the coating can include one or more pigments, dyes or colorants, a dispersant to disperse the pigment, and a pigment binder which may be a latex emulsion polymer comprised or derived from various olefinically unsaturated monomers.

Another specific embodiment includes a method for coating a substrate that includes applying a coating having a highly-carboxylated polymer that is polymerized from (i) olefinically-unsaturated hydrophobic monomers and (ii) olefinically-unsaturated carboxylic acid-functional monomers. Again, the pH of the coating is less than about 7; and the carboxylic acid-functional monomers are more than 5% by weight of the polymer. In one specific embodiment, the coating may be removed by application of alkaline solutions.

These and other embodiments, aspects, advantages, and features will be set forth in part in the description which follows, and in part will become apparent to those skilled in the art by reference to the following description of the invention and referenced drawings or by practice of the invention. The aspects and features of the invention are realized and attained by means of the instrumentalities, procedures, and combinations particularly pointed out in the appended claims and their equivalents.

### DETAILED DESCRIPTION

Specific embodiments are directed to temporary or aqueous coatings that can be applied to a surface of a substrate to form a coating that provides protection to that surface against a variety of adverse environmental conditions or coloring to that surface. The temporary coating, pigmented or non-pigmented, may be applied to and removed from a “substrate”, which refers to any surface upon which any coating compositions may be applied, and including but not limited to, for example, grass, textiles, turf, asphalt, concrete, glass, plastic, metal, rubber, walls, equipment, paper, paperboard, liner board, or a vehicle surface. A remover can be used to break up and/or solubilize the temporary coating and allow for the temporary coating to be removed from the substrate.

One specific embodiment includes a temporary or aqueous coating that is comprised of one or more pigments, dyes or colorants, dispersants to disperse the pigment, and pigment binders which may be a latex emulsion polymer comprised or derived from various olefinically-unsaturated hydrophobic monomers and carboxylic acid-functional monomers. Such monomers may be common vinyl and acrylic monomers such as, but not limited to ethyl acrylate, butyl acrylate, acrylic acid, methyl methacrylate, butyl methacrylate, methacrylic acid, styrene, vinyl acetate, butadiene and various Veova® vinyl monomers (e.g. neononanoic acid vinyl ester, neodecanoic acid vinyl ester, neoundecanoic acid vinyl ester, neododecanoic acid vinyl ester). Such monomers also include nitriles (e.g. acrylonitrile). The temporary coating is a stable, aqueous emulsion of polymers prepared from, among other things, olefinically-unsaturated carboxylic acid-functional monomers, hydrophobic monomers, and copolymerizable surfactant monomers. For example, the temporary coating (non-pigmented) comprises:

(a) an emulsion polymer polymerized from between about 4% and up to about 20% of olefinically-unsaturated carboxylic acid-functional monomers, and that copolymerize under free radical conditions, and up to about 95.5% hydrophobic monomers. Examples of latexes prepared include those prepared by reacting carboxylic acid monomer and with other monomers, such as acrylates (e.g. methyl methacrylate, butyl acrylate), vinyls (including vinyl neodecanoate, ethylene, or butadiene) or styrenes (e.g. vinyl benzene or methyl styrenes), nitriles, and allyl monomers. In several examples, the acid functionality of the latex polymer may be between about 4% and about 60% based on the total weight of the polymer. In one specific embodiment, the emulsion polymer was polymerized from a monomer mix that contained about 10% of carboxylic acid-functional monomer based on the total weight of the polymer. In some commercial embodiments, it was found that the acid functionality of the latex polymer was between about 8% and about 35% based on the total weight of the polymer.

Other olefinically-unsaturated carboxylic acid-functional monomers include itaconic acid, acrylic acid, methacrylic acid, monoalkyl maleates, crotonic acid, and fumaric acid. In several specific embodiments, the weight average molecular weight was at least 100,000 daltons. Water resistance of the temporary coating may be impacted by acid selection. For example, it was found that a temporary coating involving acrylic acid was less water resistant than temporary coatings involving methacrylic acid.

(b) “Copolymerizable surfactant monomers”, which refers to any surfactant that contain olefinic unsaturation which is capable of participating in a copolymerization reaction with various vinyl, acrylic, butadiene, nitrile, and allyl monomers (e.g., surfmer). In some embodiments, the amount of the surfactant monomer which is copolymerized into the copolymers is between about 0.5% or 1% and about 20% based on the total weight of polymer. Suitable copolymerization surfactants include those which are sulfonated or phosphated. In some embodiments, the amount of the surfactant monomer of this invention which is copolymerized into the copolymers is between about 0.5% and about 10% based on the total weight of polymer. In some embodiments, the amount of surfactant monomers that were polymerized was between about 2% and about 6% of the weight of total polymer.

In one specific embodiment, the latex particle can be stabilized by surfactants, either non-copolymerizable (or “free”) surfactants or co-polymerized surfactants or a combination thereof In one example, the surfactant is a co-polymerizable surfactant, which has performance benefits from them being attached to the polymer and an inability to migrate to the surface. Suitable copolymerizable surfactants can be ethoxylated (non-ionic), sulfonated as the ammonium, sodium or potassium salt, or phosphated (anionic) and as similar salts. A suitable copolymerizable surfactant may be ethoxylated and then further sulfonated or phosphated. The amount of surfactant may vary, as some are more effective at stabilizing the particle than others. In one embodiment, the amount of suitable surfactant was adjusted to yield a minimal amount of coagulum (e.g. <0.5%) filtered from the finished emulsion polymer.

In one specific embodiment, the pH of the emulsion is between about 1 and about 11. In some embodiments, the pH of the emulsion is between about 2 and about 5.5. In some embodiments, the pH of the emulsion is greater than about 3. In certain embodiments, the pH of the emulsion was under about 7. For example, a small amount of sodium carbonate or sodium bicarbonate that is less than 1.0% by weight may also be used. One method of controlling the pH is by the addition of an alkaline, such as sodium bicarbonate or potassium hydroxide. One of ordinary skill in the art may select an appropriate method for controlling the pH without undue experimentation.

Typical catalysts and catalytic conditions may be used to facilitate the polymerization and/or copolymeration of the constituents. For example, suitable catalysts include hydrogen peroxide, ammonium persulfate, sodium persulfate, and potassium persulfate. Examples of catalytic conditions include redox conditions using an oxidant like one of the persulfates or peroxides, and a reductant like sodium meta bisulfite from about 60° C. to 65° C. and thermal catalytic conditions using an oxidant like a persulfate or a peroxide from about 80° C. to 85° C. One of ordinary skill in the art can identify the appropriate catalysts or catalytic conditions for suitable conventional emulsion system favoring free radical polymerization.

Copolymerizable surfactants include monomers that have a hydrophobic segment, a copolymerizable olefin and an ionizable and/or water-soluble segment. The hydrophilic segment extends into the aqueous solution phase and thereby provides a steric or coulombic charge barrier against particle coagulation.

In specific embodiments, the copolymerizable surfactants contain a segment closer to hydrophobic segment containing the olefinic unsaturation and can participate in a copolymerization reaction with various hydrophobic monomers (e.g. vinyl or acrylic monomers). In some cases, it was found that there was improvement in polymerization in that cleaner (less coagulum) copolymeration occurred when the reactive segment was closer to the hydrophobic segment.

The copolymerization group can be of the same or different reactive species as that found in the latex precursor monomers so that the surfactant reacts more readily into the latex particle during the latex polymerization reaction. Suitable reactive surfactants include any surfactants having a copolymerizable group on the hydrophobic segment which are capable of being incorporated into the latex particle, e.g., Hitenol KH-10 or Hitenol BC-1025 distributed by Montello, Sipomer PAM200 or Sipomer PAM300 by Rhodia.

Any conventional process for making emulsion polymers known to one skilled in the art may be suitable for preparing specific embodiments of this invention. Generally, latex emulsion polymers can be prepared by mixing the acid monomers with the hydrophobic monomers and surfactant together to form a monomer mixture. For example, emulsification can occur readily with mixing hydrophobic monomers and surfactant in water. Typically, a monomer mixture can be prepared by charging water and dissolving surfactant in the water. Acid monomers and hydrophobic monomers can then be added. The homogenization can be optionally facilitated by the use of homogenizing equipment and/or non-copolymerizable surfactants (e.g. ethoxylates) compatible with the temporary composition. A surfactant or surfactants can then be added to the monomer mixture and stirred to form an emulsion. The monomers are mixed with water and the copolymerizable surfactants to form a pre-emulsion, and then the monomers can be “stirred” to mix.

Alternatively, monomers and copolymerizable surfactants can be mixed (e.g. without water to form a monomer mixture). Often anionic surfactants or aqueous solutions of surfactants will not dissolve in pure monomer. The monomer pre-emulsion can be prepared from water, surfactant, acid monomers and hydrophobic monomers by any conventional means that is suitable, depending on the requirements of the specific components.

The surfactant(s) may include a copolymerizable surfactant, a noncopolymerizable surfactant, or a combination of copolymerizable and noncopolymerizable surfactants. In one embodiment, noncopolymerizable surfactants can be used to form the latex particle. The many parameters of emulsion polymerization technique can be adjusted by those skilled in the art to obtain particular results such as particle size or freeze-thaw resistance. The monomers can be added to the aqueous phase gradually or in one charge. Monomers can be added continuously or in staggered finite increments.

One specific embodiment included copolymerizable surfactants, due to performance benefits from them being incorporated into the polymer. For example, the inability to migrate to the surface can reduce re-wetting and water-sensitivity. In one specific embodiment, the temporary coating prepared using copolymerized surfactants produced significantly less foam during the removal process as compared to traditional coatings. The reduction in foam can minimize slip hazards and allow for improved flocculation in waste water disposal.

The temporary coating may include a balanced formulation of hard monomers, soft monomers and copolymerizable surfactants to achieve a desired glass transition temperature (Tg). In one example, the monomers were balanced to achieve a Tg of 10° C. Further, in other examples, the overall Tg of the polymer ranged from about 70° C. down to −20° C. or between 70° C. down to −30° C.

Other optional ingredients include, water, an amount of a suitable noncopolymerizable surfactant, thickeners, hiding pigments, opacifiers, colorants, antioxidants, biocides or any other ingredients typically added to latex polymers. Optional ingredients include conventional dispersants. These additional ingredients are not critical to the function of the coating but may aid in improving the commercial utility.

Pigment can be added to the temporary composition to make a paint using methods known or developed by persons of ordinary skill in the art. Suitable hiding pigments include white opacifying hiding pigments and colored organic and inorganic pigments. Representative examples of suitable white opacifying hiding pigments include rutile and anatase titanium dioxides, lithopone, zinc sulfide, lead titanate, antimony oxide, zirconium oxide, barium sulfate, white lead, zinc oxide, leaded zinc oxide, and the like, and mixtures thereof. Examples of colored organic pigments are phthalo blue and hansa yellow. Examples of colored inorganic pigments are red iron oxide, brown oxide, ochres, and umbers. The amount of pigment in the composition can depend on the pigment color and other factors. The water content can be adjusted for the water content of the pigment dispersion. Special effect particles can be added in order to add texture or reflection characteristics to the coating or paint. Retro-reflector beads can be added to the paint as it is being applied to roadways and airports to provide reflective character to the paint. Infrared absorbers and reflectors and surface friction modifiers can also be included. The amount of pigment may affect the removablity of the temporary coating.

In one example, the temporary coating includes the use of 80% air-float kaolin/20% TiO₂. The air-float kaolin has a pH of about 4.6. The lower pH of the kaolin was thought to help the paint remain below 5.5 pH and the TiO2 gives the opacity.

In one specific embodiment, a coating that is essentially the latex is neutralizer-free. For example, ammonia is not present in either the salt form or any free ammonia. An ammonia-free latex can be prepared by omitting ammonia from the mixture.

In one specific embodiment, the coating can be added to conventional water-based latex paint or coating so that it renders the mixture removable or temporary. In this embodiment, the temporary coating can include the carboxylic acid-functional monomers between about 4% and up to about 60% by weight of the polymer. In another embodiment, the coating can have between about 4% and up to about 40% of carboxylic acid-functional monomers, which have olefinic unsaturation and that copolymerize under free radical conditions. In another embodiment, the temporary coating can have between about 4% and up to about 20% of carboxylic acid-functional monomers, which have olefinic unsaturation and can copolymerize under free radical conditions.

The temporary coating can be applied to a substrate using methods known or developed by persons of ordinary skill in the art. Such methods may include spraying, brushing, rolling or any other satisfactory method of applying a coating to a substrate.

The temporary coating can be used on surfaces that are hard, soft, rough, smooth or have been sealed in order to make the removal of the paint complete. While the coating composition can be applied to a porous substrate, some of the coating composition may be lodged in the pores of the surface making it difficult to remove. More intensive scrubbing or the use of a pressure washer with the remover solution will achieve a total removal of the paint in such cases.

In one specific embodiment, the coating may be removed by application of alkaline solutions. The remover solution can have a pH of from about 8 to about 14. The remover solution is applied to the coating or paint and brushed or otherwise agitated and allowed to set for a few minutes and then removed by water. While not intending to be bound by theory, it is believed that the alkalis react with the carboxylic acid groups to form a salt which renders the coating dispersable.

In another specific embodiment, the above identified carboxylic acids monomers are homopolymerized and then mixed with conventional latex paints (in most cases difficult to remove). In this embodiment, conventional latex becomes removable upon the application of an alkaline solution. In some examples the acid content of the mixture can be about 15%, and in other examples the acid content can be about 20%.

Specific examples of the remover solution can contain amines, ammonium hydroxide, ammonium carbonate, sodium hydroxide, potassium hydroxide, and sodium carbonate. The remover solutions are brought into contact with the removable composition for a few minutes and agitated by a sponge, mop or brush and then washed away with water. Other alkalis can be substituted for the ammonium hydroxide to reduce the objectionable odor of ammonia.

The remover may include a penetrant, such as M-Pro 7 CLP, Break Free, for application to weaponry for military applications, Ethfac 124 (2-ethylhexyl ethoxylate phosphate) or Ethfac 104 (2-ethylhexyl phosphate) for other applications. One of ordinary skill in the art can determine an appropriate remover solution without undue experimentation.

### EXAMPLES

The following examples are intended to illustrate various specific embodiments of the invention.

### Example 1

200 ml of deionized water and 1.0 g of a sulfonate copolymerizable stabilizer surfactant (Rhodia Sipomer COPS-I) were placed in a resin kettle. The kettle was fitted with a stainless steel agitator, gasket, 4-hole lid and clamped together. The assembly was further fitted with a Claisen tube, thermocouple, condenser, nitrogen inlet and two-port adapter. The thermocouple was attached to a temperature controller. The agitator, in the kettle, was set at 100 rpm, and the kettle heated to 82° C. with a nitrogen blanket.

While this was heating, the monomer pre-emulsion was prepared by mixing 210 ml of deionized water, 40.0 g of methacrylic acid and 0.5 g of sodium bicarbonate. The mixture was stirred for 5 minutes until the foam dissipated. 2.0 g COPS I, 20.0 g of E-sperse 100 (Ethox Chemicals, Inc.) and 5.0 g of Rhodacal DS-10 (Rhodia) were added and stirred for 5 minutes to mix the surfactants. 100.0 g of Veova-10 (Hexion), 134.0 g of butyl acrylate and 126.0 g of methyl methacrylate were added to the mixture, which had a total volume of 680 ml. This was mixed and allowed to stir for 30 minutes.

An initial catalyst was prepared by dissolving 0.25 g of ammonium persulfate in 2.0 ml of deionized water.

A delay catalyst was prepared by dissolving 1.0 g of ammonium persulfate in 40.0 ml of deionized water. 0.3 g of 70% t-butyl hydroperoxide and 0.2 g of E-sperse 100 was then added to the mixture. The delay catalyst solution was then drawn into a 60 cc syringe and mounted on a syringe pump. The catalyst solution occupied 40 cc in the syringe and the pump was set at 0.2 ml/minute to deliver the contents in 195 minutes.

Upon reaching 82 ° C., the nitrogen blanket was stopped and a 3% initial monomer (20.4 ml) charge was pumped to the reactor. The initial catalyst was added through the addition port and allowed to initiate for 15 minutes.

After the initiation hold period was over, the delays were started with the monomer pre-emulsion going in over 180 minutes and the catalyst going in over 195 minutes. The batch held between 82° C. and 84° C. during this time. After the catalyst flow ended, 0.3 g of t-butyl hydro peroxide was added and held for 15 minutes. The temperature was then reduced to 65° C., 2 ml of 0.1% ferrous sulfate solution was added, followed by 0.3 g of t-butyl hydroperoxide and a solution of 0.3 g of sodium formaldehyde sulfoxylate in 2 g of water. After 15 minutes, 0.3 g of t-butyl hydroperoxide and 0.3 g of sodium formaldehyde sulfoxylate were added. The batch was cooled to 45° C. and 0.1 g of Troysan 586 biocide was added. The batch was filtered through a 100 micron filter bag. The grit filtered was 0.2 g. The agitator blades and temperature probe were clean. The product was a white latex, 45% solids, pH 3.4, 150 cps in viscosity.

### Example 2

To a 1-liter resin kettle was charged 200 g of deionized water and 1.0 g of COPS-I copolymerizable stabilizer (Rhodia). The kettle was fitted with a stainless steel agitator, gasket, 4-hole lid and clamped together. The assembly was further fitted with a Claisen tube, thermocouple, condenser, nitrogen inlet and two-port adapter. The thermocouple was attached to a temperature controller.

The agitator was set at 100 rpm, and the kettle heated to 82° C. with a nitrogen blanket. While this was heating, the monomer pre-emulsion was prepared. To a 1500 ml beaker was added 210 g deionized water, 40.0g of acrylic acid and 2.0 g of sodium bicarbonate. A magnetic stir bar was added and this stirred for 5 minutes until the foam dissipated. To the beaker was then added 2.0 g COPS I, 20.0 g of E-sperse 100 (Ethox Chemicals, Inc.) and 5.0 g of Rhodacal DS-10 (Rhodia). This was allowed to stir 5 minutes to mix the surfactants. To the beaker was then added 100.0 g of Veova-10 (Hexion), 134.0 g of butyl acrylate and 126.0 g of methyl methacrylate for a total volume of 680 ml. This was mixed and allowed to stir for 30 minutes.

The initial catalyst was prepared by dissolving 0.25 g of ammonium persulfate in 2.0 g of deionized water. The delay catalyst was prepared by dissolving 1.0 g of ammonium persulfate in 40.0 g of deionized water. To this was then added 0.3 g of 70% t-butyl hydroperoxide and 0.2 g of E-sperse 100. The delay catalyst solution was then drawn into a 60 cc syringe and mounted on a syringe pump. The catalyst solution occupied 40 cc in the syringe and the pump was set at 0.2 ml/minute to deliver the contents in 195 minutes.

Upon reaching 82° C., the nitrogen blanket was stopped and a 3% initial monomer (20.4 ml) charge was pumped to the reactor. The initial catalyst was added through the addition port and allowed to initiate for 15 minutes.

After the initiation hold period was over, the delays were started with the monomer pre-emulsion going in over 180 minutes and the catalyst going in over 195 minutes. The batch held between 82° C. and 84° C. during this time. After the catalyst flow ended, 0.3 g of t-butyl hydro peroxide was added and held for 15 minutes. The temperature was then reduced to 65° C., 2 ml of 0.1% ferrous sulfate solution added, followed by 0.3 g of t-butyl hydroperoxide and a solution of 0.3 g of sodium formaldehyde Sulfoxylate in 2 g of water.

After 15 minutes, 0.3 g of t-butyl hydroperoxide and 0.3 g of sodium formaldehyde sulfoxylate were added. No exotherm was noted. The batch was cooled to 45° C. and 0.1 g of Troysan 586 biocide was added. The batch was filtered through a 100 micron filter bag. The grit filtered was 0.2 g. The agitator blades and temperature probe were clean. The product was a white latex, 45% solids, pH 5.38, 150 cps in viscosity.

### Example 3

The general procedures of Examples 1 or 2 were followed except Hitenol KH-10 (e.g. 17 grams) was introduced into the procedure in place of the Rhodacal DS-10 and E-sperse 100.

### Example 4

The general procedures of Examples 1 or 2 were followed except BC1025 (e.g. 17 grams) was introduced into the procedure in place of the Rhodacal DS-10 and E-sperse 100.

### Example 5

The general procedures of Examples 1 or 2 were followed except PAM-200 was introduced into the procedure in place of the Rhodacal DS-10 and E-sperse 100.

### Example 6

The general procedures of Examples 1 or 2 were followed except PAM-300 was introduced into the procedure in place of the Rhodacal DS-10 and E-sperse 100.

### Example 7

A paint mixture was prepared by, among other things, mixing (using water and a grinding aid) in about 70-300 grams of kaolin or TiO₂ (dry powder) with the mixtures prepared according to Examples 1-6.

### Example 8

A paint mixture was prepared by, among other things, mixing in 80/20 mix of kaolin/TiO₂ mix. The opacifying pigments were ground at high speed using water and a dispersant (Disperbyk 2010). The components included the following:

1) Water: 100 grams

2) Disperbyk 2010: 72 grams—this amount was derived by adding the products of multiplying the TiO2 by 0.12, and multiplying the Peerless 1 by 0.27. So, the 2010 was loaded at 12% of Ti02, based on dry powder, plus 27% of Peerless 1 Air-float Kaolin, based on dry powder.

3) Titanium Dioxide: 60 grams

4) Peerless 1 Airfloat Kaolin: 240 grams

The water and dispersant are added together. They were mixed together until blended thoroughly. While mixing at approximately 500 RPM, the TiO2 and Peerless 1 were added slowly. Once all of the powder was added, the high-speed disperser was turned up to 1000 RPM's and allowed to mix for 30 to 45 minutes. The use of a defoamer was used in certain examples—Air Products EnviroGem AD01 defoamer.

This mix was then poured into mixtures prepared according to Examples 1-6 and was mixed along with appropriate colorants, solvents, coalescing agents, and any other additives that yield the desired performance characteristics.

### Example 9

To a 1-liter resin kettle was charged 200 g of deionized water and 1.0 g of COPS-I copolymerizable stabilizer surfactant (Rhodia). The kettle was fitted with a stainless steel agitator, gasket, 4-hole lid and clamped together. The assembly was further fitted with a Claisen tube, thermocouple, condenser, nitrogen inlet and two-port adapter. The thermocouple was attached to a temperature controller.

The agitator was set at 100 rpm, and the kettle heated to 82° C. with a nitrogen blanket. While this was heating, the monomer pre-emulsion was prepared. To a 1500 ml beaker was added 218 g deionized water, 48.0 g of methacrylic acid, and 0.5 g of sodium bicarbonate. A magnetic stir bar was added and this stirred for 5 minutes until the foam dissipated. To the beaker was then added 2.0 g COPS-I, and 17 g of Hitenol KH-10 (an anionic non-APE copolymerizable surfactant produced by Dai-Ichi Kogyo Seiyaku Co., Ltd. of Japan and sold in the U.S. by Montello, Inc.). This was allowed to stir 5 minutes to mix the surfactants. To the beaker was then added 100.0 g of Veova-10 (Hexion), 152.0 g of butyl acrylate and 100.0 g of methyl methacrylate for a total volume of 680 ml. This was mixed and allowed to stir for 30 minutes.

The initial catalyst was prepared by dissolving 0.2 g of ammonium persulfate in 2.0 g of deionized water. The delay catalyst was prepared by dissolving 1.0 g of ammonium persulfate in 40.0 g of deionized water. To this was then added 0.3 g of 70% t-butyl hydroperoxide and 0.2 g of E-sperse 100. The delay catalyst solution was then drawn into a 60 cc syringe and mounted on a syringe pump. The catalyst solution occupied 40 cc in the syringe and the pump was set at 0.2 ml/minute to deliver the contents in 195 minutes.

Upon reaching 82° C., the nitrogen blanket was stopped and a 3% initial monomer (20.4 ml) charge was pumped to the reactor. The initial catalyst was added through the addition port and allowed to initiate for 15 minutes. An exotherm to 86° C. was noted.

After the initiation hold period was over, the delays were started with the monomer pre-emulsion going in over 180 minutes and the catalyst going in over 195 minutes. The batch held between 82° C. and 84° C. during this time. After the catalyst flow ended, 0.3 g of t-butyl hydro peroxide was added and held for 15 minutes. The temperature was then reduced to 65° C., 2 ml of 0.1% ferrous sulfate solution added, followed by 0.3 g of t-butyl hydroperoxide and a solution of 0.3 g of sodium formaldehyde sulfoxylate in 2 g of water. A slight exotherm was noted. After 15 minutes, 0.3 g of t-butyl hydroperoxide and 0.3 g of sodium formaldehyde Sulfoxylate were added. The batch was cooled to 45° C. and 0.1 g of Troysan 586 biocide was added. The batch was filtered through a 100 micron filter bag. The grit filtered was 0.8 g. The agitator blades and temperature probe were clean. The product was a white latex, 45% solids, pH 2.1 at 13.3° C., 150 cps in viscosity.

### Example 10

Each of the temporary coatings of Examples 1-9 were (1) applied to a concrete floor and/or an automobile surface, (2) exposed to elements (including foot traffic), and (3) removed using an amine (including NH₄OH) remover.

The temporary coating dried in about 30 minutes.

The above detailed description, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

1. An aqueous coating comprising:
a) a highly-carboxylated emulsion polymer that is polymerized from
(i) olefinically-unsaturated hydrophobic monomers and
(ii) olefinically-unsaturated carboxylic acid-functional monomers;
b) surfactant; and
c) water,
wherein the carboxylic acid-functional monomers are more than 4% by weight of the polymer, and the pH is less than about 7.

2. The coating as claimed in claim 1, wherein the hydrophobic monomers are selected from the group consisting of ethyl acrylate, butyl acrylate, methyl methacrylate, butyl methacrylate, 2-ethylhexyl acrylate, styrene, vinyl acetate, butadiene, neononanoic acid vinyl ester, neodecanoic acid vinyl ester, neoundecanoic acid vinyl ester, neododecanoic acid vinyl ester and combinations thereof and the carboxylic acid-functional monomers are selected from the group consisting of acrylic acid, methacrylic acid, Itaconic acid, crotonic acid, mono alkyl maleate, maleic acid, and fumaric acid, or combinations thereof.

3. The coating as claimed in claim 1, further comprising nitrile monomers.

4. The coating as claimed in claim 1, wherein the pH of the composition is between about 3 and about 5.5.

5. The coating as claimed in claim 1, wherein the carboxylic acid-functional monomers are between about 5% and about 60% by weight of the polymer.

6. The coating as claimed in claim 1, further comprising a pigment.

7. The coating as claimed in claim 1, wherein the carboxylic acid-functional monomers are between about 5% and 40% by weight of the polymer.

8. The coating as claimed in claim 1, wherein the carboxylic acid-functional monomers are between about 8% and about 35% by weight of the polymer.

9. An aqueous emulsion of polymers that are polymerized from olefinically-unsaturated hydrophobic monomers; olefinically-unsaturated carboxylic acid-functional monomers, and olefinically-unsaturated copolymerizable surfactant monomers.

10. The emulsion as claimed in claim 9, wherein the carboxylic acid-functional monomers are between about 4% and about 60% of the weight of the polymer.

11. The emulsion as claimed in claim 9, wherein the carboxylic acid-functional monomers are between about 8% and about 35% of the weight of the polymer.

12. The emulsion as claimed in claim 9, wherein the surfactant monomer is incorporated into the polymer and is between about 1% and about 20% by weight of the polymer.

13. The emulsion as claimed in claim 9, wherein the surfactant monomers are between about 2% and about 6% by weight of the polymer.

14. The emulsion as claimed in claim 9, wherein the copolymerizable surfactant monomers are sulfonated, ethoxylated, or phosphated.

15. The emulsion as claimed in claim 9, whereby the emulsion is capable of binding a pigment dispersion.

16. The emulsion as claimed in claim 15, wherein the pigment dispersion contains opacifying hiding pigment, colored organic pigment, inorganic pigment, or a combination thereof.

17. A method for coating a substrate comprising:
applying a coating comprising a highly-carboxylated polymer that is polymerized from (i) olefinically-unsaturated hydrophobic monomers and (ii) olefinically-unsaturated carboxylic acid-functional monomers; wherein the pH of the coating is less that about 7; and the carboxylic acid-functional monomers are more than 5% by weight of the polymer.

18. The method as claimed in clam 17, further comprising:
removing the coating by applying an alkaline remover.

19. (canceled)

20. (canceled)

21. (canceled)

22. (canceled)

23. (canceled)

24. (canceled)

25. (canceled)

26. (canceled)

27. (canceled)
